(19) United States
(12) Patent Application Publication
(10) Pub. No.: US 2022/0207407 A1
(43) Pub. Date: Jun. 30, 2022

(54) LOCALIZATION OF MACHINE LEARNING MODELS TRAINED WITH GLOBAL DATA

(71) Applicant: salesforce.com, inc., San Francisco, CA (US)

(72) Inventors: Yuxi Zhang, San Francisco, CA (US); Kexin Xie, San Mateo, CA (US)

(21) Appl. No.: 17/134,430

(22) Filed: Dec. 27, 2020

(51) Int. Cl. G06N 20/00; G06N 5/04; G06F 16/28

(52) U.S. Cl. CPC G06N 20/00; G06F 16/28; G06N 5/04

(57) ABSTRACT

Systems, devices, and techniques are disclosed for localization of machine learning models trained with global data. Data sets of event data for users may be received. The data sets may belong to separate groups. The data sets of event data may be combined to generate a global data set. A matrix factorization model may be trained using the global data set to generate a globally trained matrix factorization model. A localization group data set may be generated including event data from the global data set for users from a first of the groups. The globally trained matrix factorization model may be trained with the localization group data set to generate a localized matrix factorization model for the first of the groups.

### BACKGROUND

Recommendation systems for products use a user's past behavior to determine what products to recommend to the user in order to induce the user to purchase, or take some other action, in relation to the product. Various machine learning models may be used in recommendation systems. Machine learning models trained to make recommendations for users of a particular basis may be trained using the data for the user from that business. This data may be too sparse to effectively train the machine learning model to generate recommendations that will be useful to the user.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for suitable for localization of machine learning models trained with global data according to an implementation of the disclosed subject matter.

FIG. 2A shows an example arrangement suitable for localization of machine learning models trained with global data according to an implementation of the disclosed subject matter.

FIG. 2B shows an example arrangement suitable for localization of machine learning models trained with global data according to an implementation of the disclosed subject matter.

FIG. 2C shows an example arrangement suitable for localization of machine learning models trained with global data according to an implementation of the disclosed subject matter.

FIG. 2D shows an example arrangement suitable for localization of machine learning models trained with global data according to an implementation of the disclosed subject matter.

FIG. 2E shows an example arrangement suitable for localization of machine learning models trained with global data according to an implementation of the disclosed subject matter.

FIG. 3A shows an example arrangement suitable for localization of machine learning models trained with global data according to an implementation of the disclosed subject matter.

FIG. 3B shows an example arrangement suitable for localization of machine learning models trained with global data according to an implementation of the disclosed subject matter.

FIG. 3C shows an example arrangement suitable for localization of machine learning models trained with global data according to an implementation of the disclosed subject matter.

FIG. 4A shows an example arrangement suitable for localization of machine learning models trained with global data according to an implementation of the disclosed subject matter.

FIG. 4B shows an example arrangement suitable for localization of machine learning models trained with global data according to an implementation of the disclosed subject matter.

FIG. 4C shows an example arrangement suitable for localization of machine learning models trained with global data according to an implementation of the disclosed subject matter.

FIG. 5 shows an example procedure suitable for localization of machine learning models trained with global data according to an implementation of the disclosed subject matter.

FIG. 6 shows an example procedure suitable for localization of machine learning models trained with global data according to an implementation of the disclosed subject matter.

FIG. 7 shows an example procedure suitable for localization of machine learning models trained with global data according to an implementation of the disclosed subject matter.

FIG. 8 shows an example arrangement suitable for localization of machine learning models trained with global data according to an implementation of the disclosed subject matter.

FIG. 9 shows an example procedure suitable for localization of machine learning models trained with global data according to an implementation of the disclosed subject matter.

FIG. 10 shows a computer according to an implementation of the disclosed subject matter.

FIG. 11 shows a network configuration according to an implementation of the disclosed subject matter.

### DETAILED DESCRIPTION

Techniques disclosed herein enable localization of machine learning models trained with global data, which may allow for a matrix factorization model to be trained used global data set including data from multiple groups and localized to one of the groups using a group data set for that group. Event data for users may be received for users belonging to multiple groups. The event data from the multiple groups may be combined into a global data set by merging the event data for users to generate a semi-sparse matrix of event data. A globally trained matrix factorization model may be trained using the global data set by performing non-negative matrix factorization on the semi-sparse matrix of event data generated from the global data set. A localization group data set may be generated for a group using event data in the global data set for users from the group. The globally trained matrix factorization model may be localized to generate a dense matrix for a localized matrix factorization model by performing non-negative matrix factorization on a local semi-sparse matrix generated by unioning the localization group data set to the globally trained matrix factorization model.

Event data for users may be received for users belonging to multiple groups. The groups may be any suitable groups, such as organizations and businesses, and may be, for example, tenants of a multi-tenant database system. For example, a customer relationship management database system may be used by multiple different organizations, each of which may be a tenant of the customer relationship management database system. Each tenant of a multi-tenant database system may store event data for its users in the multi-tenant data system. The event data for users belonging to the groups may be data related to user interactions with items, such as products, made available by the groups. Event data for a user may include items that a user has interacted with through actions and the actions taken by the user in interacting with the items. The actions may be, for example, related to the purchasing of the products, including, for example, submitting a search query to an online store that returns a webpage for a product as a result, viewing a webpage for a product, using any form of electronic communication to inquire or ask questions about a product, placing a product in a shopping cart of an online store, and purchasing a product from the online store. The event data may, for example, be a row in a database, with each column of the row representing an event, for example, a user's interaction with a specific item, and a value stored in the column representing a user's preference for the event represented by the column. For example, a first column may represent a user putting an item in their online cart, a second column may represent the user purchasing that item, a third column may represent the user putting a second item in their online car, and a fourth column may represent the user purchasing the second item. A user may be, for example, a customer or subscriber of the groups that have event data for the user.

Event data from each of the groups may be stored separately. For example, each tenant of a multi-tenant database system may have event data for its users segregated from event data for other groups users, even when the users overlap between groups. Each group may only be able to access its own event data, for example, with each tenant of a multi-tenant database system only having access to the event data stored or otherwise owned by that tenant in the multi-tenant database system, and not having access to event data stored by any other tenant unless granted access by that tenant. This may maintain both the proprietary nature of a group's event data and user privacy.

The event data from the multiple groups may be combined into a global data set by merging the event data for users to generate a semi-sparse matrix of event data. Event data for unique users from each of the multiple groups may be added to the global data set through, for example, adding event data for each unique user as a row to the semi-sparse matrix of event data. The columns of the semi-sparse matrix of event data may include all of the unique columns across all of the event data for the users from the multiple groups. Event data for users who have event data in more than one of the groups may have their event data from these groups merged. For example, a customer or subscriber may have interacted with products from different businesses that are tenants of the same multi-tenant database, resulting in different sets of event data for that customer or subscriber being stored in the multi-tenant database by each tenant whose products the customer or subscriber interacted with. To merge event data from multiple groups for the same user, the event data for unique columns from the multiple groups may be appended to form the row for the user in the semi-sparse matrix of event data, and values for columns common to event data from more than one of the multiple groups may be merged, for example, averaged or combined in any suitable manner, to produce single values for the common columns. For example, the same customer may purchase the same product from two different businesses, resulting in event data for that customer from the two different businesses having a common column representing the purchase of that product. To preserve data privacy of both users and groups, identifiers for the users from the event data may be hashed or otherwise depersonalized in a consistent manner before event data from multiple groups is merged. The depersonalization of the identifiers for users in the event data may result in the same user having the same depersonalized identifier across every group that has event data for that user, allowing event data from across the multiple groups for the same user to be merged without the original user identifier.

A globally trained matrix factorization model may be trained using the global data set by performing non-negative matrix factorization on the augmented semi-sparse matrix of event data generated from the global data set. Performing non-negative matrix factorization on the augmented semi-sparse matrix of event data may generate a dense matrix with no empty values. The dense matrix may be the globally trained matrix factorization model for the event data from the multiple groups used to generate the global data set. The globally trained matrix factorization model may represent each user's preferences towards events independent of groups. For example, the globally trained matrix factorization model may represent a customer's preference towards a product independent of which business is offering the product.

A localization group data set may be generated for a group using event data in the global data set for users from the group. To localize the globally trained matrix factorization model to one of the groups whose event data was used to generate the global data set, a localization group data set may be generated. The localization group data set may be generated from event data in the global data set for the users from the group to which the globally trained matrix factorization model will be localized. All of the event data form the global data set for any of the users of the group may be used to generate the localization group data set. This may include, for example, event data from across all other groups whose event data is in the global data set for users that are in the group for which the globally trained matrix factorization model will be localized. For example, to a global data set that includes event from three tenants of a multi-tenant database system may be used to generate a globally trained matrix factorization model. To localize the globally trained matrix factorization model to a first tenant of a multi-tenant database system, a localization group data set may be generated using all of the event data in the global data set for the users of the first tenant. This may include event data for those users from the other two tenants whose event data is in the global data set.

The globally trained matrix factorization model may be localized to generate a dense matrix for a localized matrix factorization model by performing non-negative matrix factorization on a local semi-sparse matrix generated by unioning the localization group data set to the globally trained matrix factorization model. The localization group data set may be unioned to the globally trained matrix factorization model, which may be a dense matrix, generating a local semi-sparse matrix. The local semi-sparse matrix may include a set of rows with no missing values from the dense matrix of the globally trained matrix factorization model and a set of rows with missing values from the localization group data set. Non-negative matrix factorization may be performed on the local semi-sparse matrix. Performing non-negative matrix factorization on the local semi-sparse matrix of event may generate a dense matrix with no empty values. The dense matrix may be the localized matrix factorization model for the group whose users' event data was used to generate the localization group data set. For example, if the localization group data set was generated using event data for user's of a first tenant of a multi-tenant database system, the localized matrix factorization model generated using that localization group data set may be localized to that first tenant.

A different localized matrix factorization model may be generated for each group whose event data is used in a global data set. For example, if a global data set includes event data from five different groups, five different localized matrix factorization models may be generated. Each of the five different localized matrix factorization models may be localized to a different one of the five groups through use of different one of five localization group data sets. Each localization group data set may include event data from the global data set for users of the group the localization group data set will be used to generate a localized matrix factorization model for. This may allow the globally trained matrix factorization model to be localized to the different groups, generating localized matrix factorization models that incorporate all of the event data across all groups in the global data set while also being localized to different ones of the groups. For example, each of five tenants in a multi-tenant database system may have its own localized matrix factorization model whose generation may incorporate event data from all five tenants while being localized based on the specific users of each tenant.

The localized matrix factorization models may be used in any suitable manner. For example, the localized matrix factorization model for a tenant of a multi-tenant database system may be incorporated into a product recommendation system associated with the multi-tenant database system. The product recommendation system may, for example, use the localized matrix factorization model for a tenant to determine what products to recommend to a user, including users for whom the tenant has event data and new users, who is using a online shopping web-site or application of that tenant.

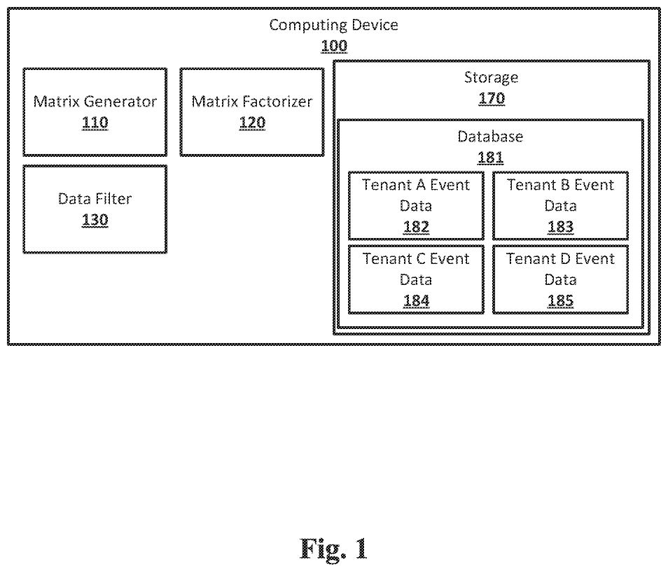

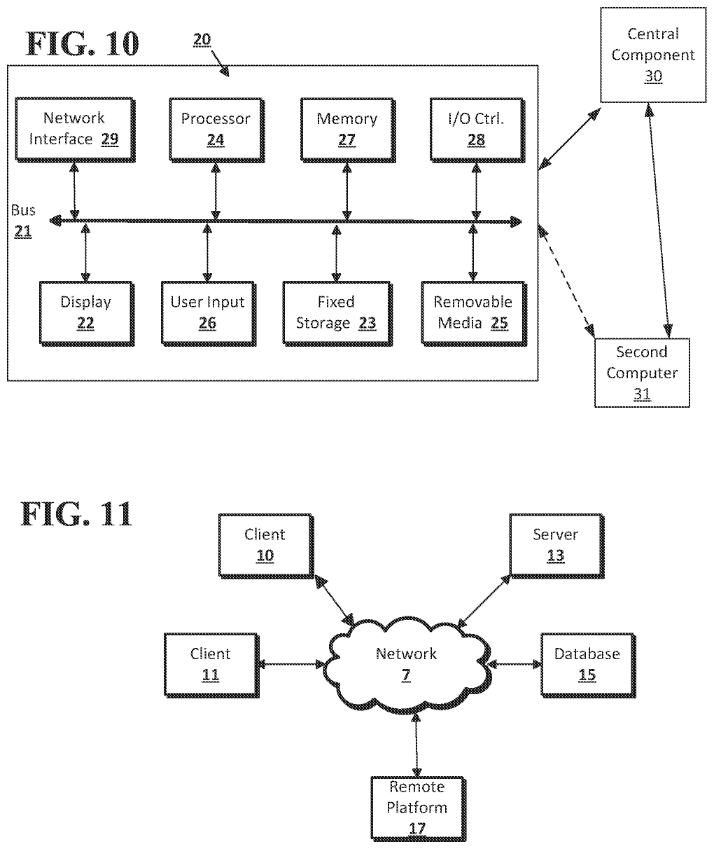

FIG. 1 shows an example system for suitable for localization of machine learning models trained with global data according to an implementation of the disclosed subject matter. A computing device 100 may be any suitable computing device, such as, for example, a computer 20 as described in FIG. 10, or component thereof, for implementing localization of machine learning models trained with global data. The computing device 100 may include a matrix generator 110, a matrix factorizer 120, a data filter 130, and a storage 170. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs).

The matrix generator 110 may be any suitable combination of hardware and software of the computing device 100 for generating matrices from data, such as event data. The matrix generator 110 may, for example, combine or merge event data from multiple groups to generate a semi-sparse matrix for a global data set. When generating the semi-sparse matrix for the global data set, the matrix generator 110 may merge event data from different groups that has the same row identifier, for example, event data from different tenants that is for the same user. The matrix generator 110 may union selected event data from the semi-sparse matrix for the global data set to a dense matrix to generate a local semi-sparse matrix. The matrix generator 110 may use any suitable form of hashing or other form of depersonalization when generating matrices from event data, for example, when data for users of different groups are combined to generate the a matrix.

The matrix factorizer 120 may be any suitable combination of hardware and software of the computing device 100 for performing matrix factorization. The matrix factorizer 120 may, for example, perform non-negative matrix factorization on semi-sparse matrices of event data, generating dense matrices. For example, the matrix factorizer 120 may perform non-negative matrix factorization on the semi-sparse matrix of event data for a global data set to generate a dense matrix for a globally trained matrix factorization model. The matrix factorizer 120 may perform non-negative matrix factorization on local semi-sparse matrix to generate a dense matrix for a localized matrix factorization model.

The data filter 130 may be any suitable combination of hardware and software of the computing device 100 for filtering a data set to select and extract specified data. The data filter 130 may, for example, select and extract event data for specified users from a global data set, for example, extracting rows from a semi-sparse matrix for the global data set. The specified users may be, for example, users of a particular group from among the groups whose event data was combined into the global data set by the matrix generator 120.

The storage 170 may be any suitable combination of hardware and software for storing data. The storage 170 may include any suitable combination of volatile and non-volatile storage hardware, and may include components of the computing device 100 and hardware accessible to the computing device 100, for example, through wired and wireless direct or network connections. The storage 170 may store a database 181. The database 181 may be, for example, a multi-tenant database. The database 181 may store tenant A event data 182, tenant B event data 183, tenant C event data 184, and tenant D event data 185. The tenant A event data 182 may be event data for users of a tenant A of the database 181, which may be, for example, a business or other organization that may have users, who may be, for example, customers or subscribers. The tenant B event data 183 may be event data for users of a tenant B of the database 181, which may be, for example, a business or other organization that may have users, who may be, for example, customers or subscribers. The tenant C event data 184 may be event data for users of a tenant C of the database 181, which may be, for example, a business or other organization that may have users, who may be, for example, customers or subscribers. The tenant D event data 185 may be event data for users of a tenant D of the database 181, which may be, for example, a business or other organization that may have users, who may be, for example, customers or subscribers. The event data may be data may be, for example, data regarding items that a user has interacted with through actions and the actions taken by the user in interacting with the items. The tenant A event data 182, tenant B event 183, tenant C event data 184, and tenant D event data 185 may be stored in the database 181 in any suitable manner. For example, each user of tenant A may have their event data stored in a separate row of the database 181, with the rows for the users of tenant A forming the tenant A event data 182. Event data for different tenants of the database 181 may be stored in the same table of the database 181, or may be stored in different tables. The database 181 may segregate access to event data on a per-tenant basis, such that, for example, tenant A may have access to tenant A event data 182 but not to tenant B event 183, tenant C event data 184, or tenant D event data 185.

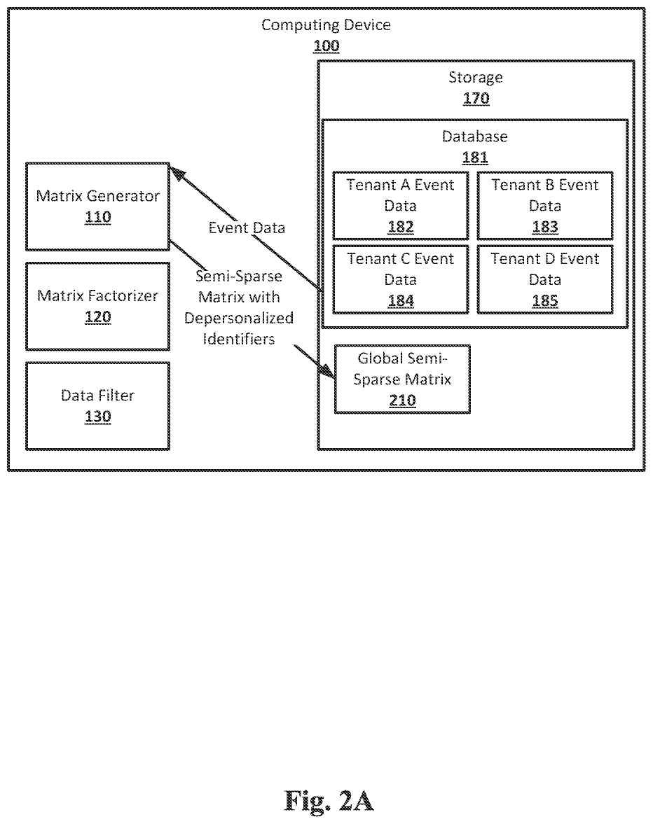

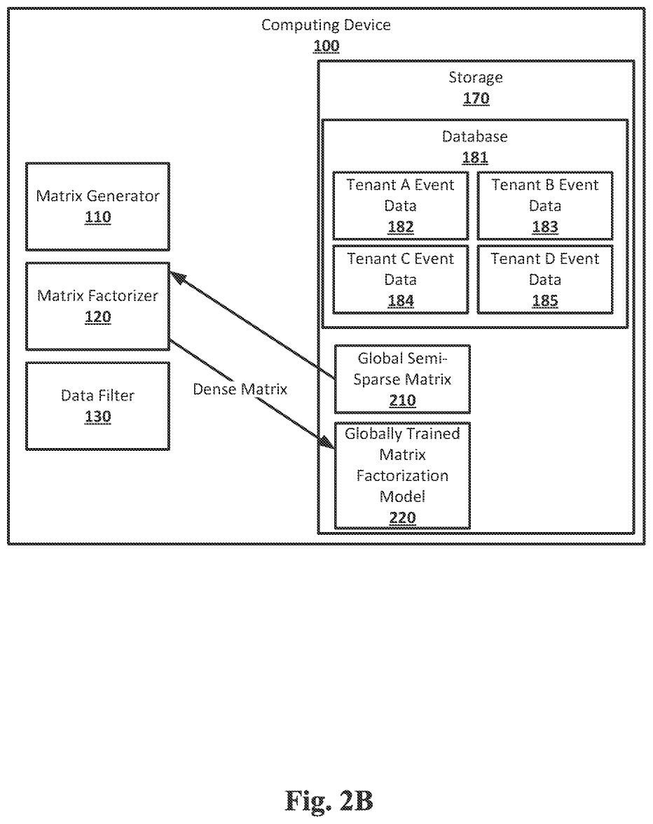

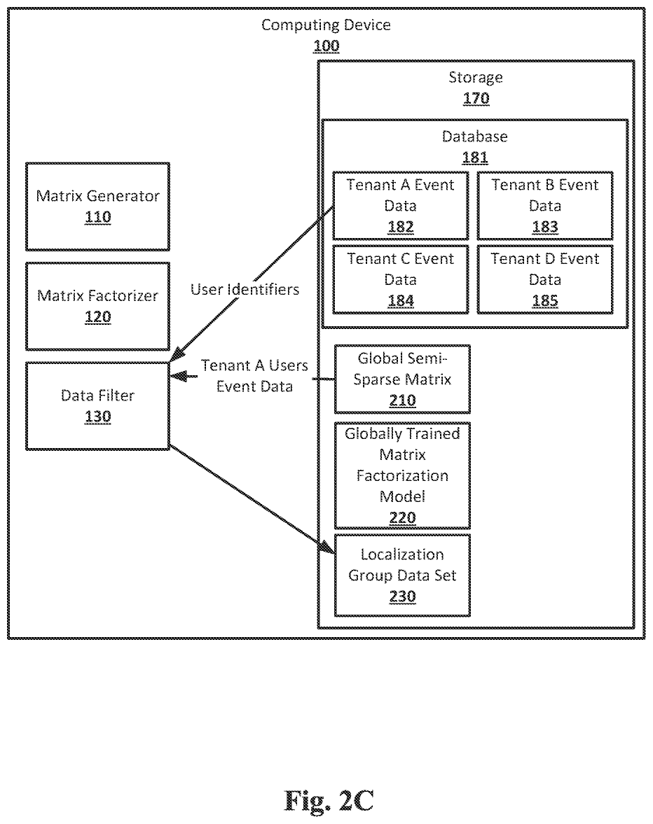

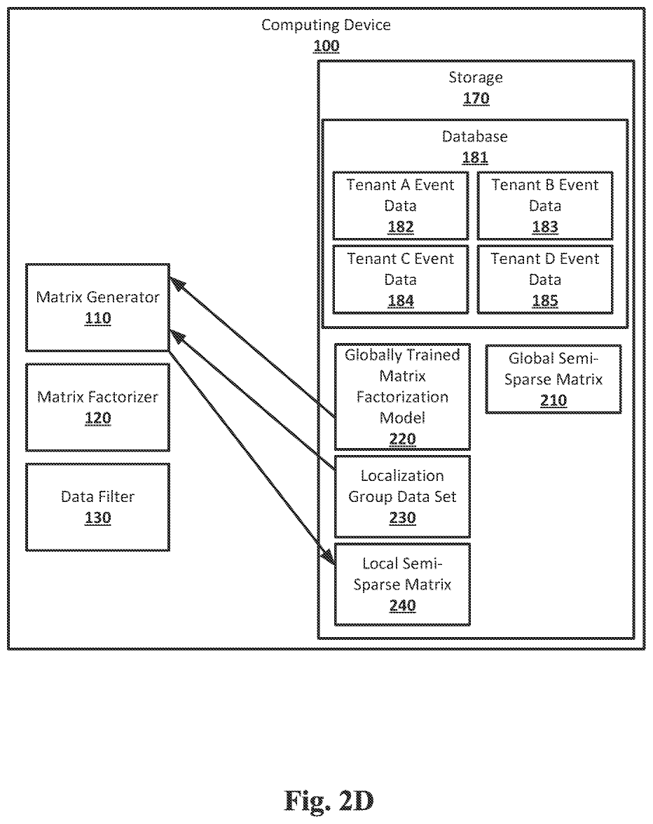

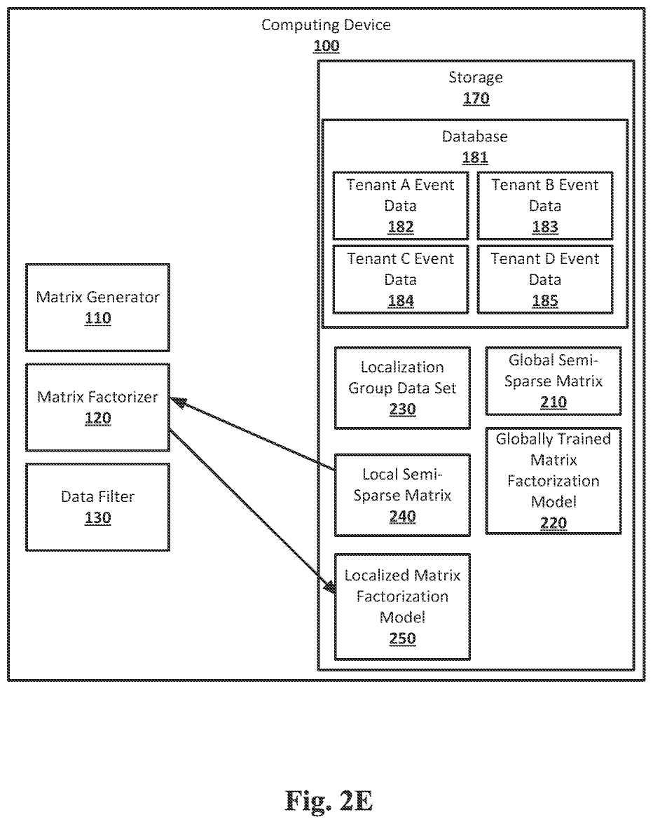

FIG. 2A shows an example arrangement for suitable for localization of machine learning models trained with global data according to an implementation of the disclosed subject matter. The matrix generator 110 may combine event data to generate a global semi-sparse matrix 210, which may be a semi-sparse matrix for a global data set. The event data combined by the matrix generator 110 may be event data for two or more groups, for example, two or more tenants of the database 181. For example, the matrix generator 110 may combine tenant A event data 182, tenant B event 183, tenant C event data 184, and tenant D event data 185 to generate the global semi-sparse matrix 210, which may be a global data set for the tenant A, tenant B, tenant C, and tenant D. The global semi-sparse matrix 210 may include, for example, a row for each unique user and a column for each unique event from among the tenant A event data 182, tenant B event 183, tenant C event data 184, and tenant D event data 185. If a user and event are common to more than one of the tenant A event data 182, tenant B event 183, tenant C event data 184, and tenant D event data 185, the values for the user for that event may be merged in any suitable manner, including, for example, averaging the values. The global semi-sparse matrix 210 may be stored, for example, in the storage 170.

Before generating the global semi-sparse matrix 210, the matrix generator 110 may hash or otherwise depersonalized identifiers for users from the tenant A event data 182, tenant B event 183, tenant C event data 184, and tenant D event data 185 to generate a depersonalized identifier for each user. The depersonalized identifiers may be stored in the global semi-sparse matrix 210 instead of the user identifiers from the tenant A event data 182, tenant B event 183, tenant C event data 184, and tenant D event data 185. Common users from among the tenant A event data 182, tenant B event 183, tenant C event data 184, and tenant D event data 185 may be identified based on matching depersonalized identifiers.

FIG. 2B shows an example arrangement for suitable for localization of machine learning models trained with global data according to an implementation of the disclosed subject matter. The matrix factorizer 120 may generate a dense matrix from the global semi-sparse matrix 210. The dense matrix generated by the matrix factorizer 120 may be a globally trained matrix factorization model 220, which may be a model for all of the users for all of the tenants of the database 181 based on the tenant A event data 182, tenant B event data 182, tenant C event data 184, and tenant D event data 185. The matrix factorizer 120 may, for example, perform non-negative matrix factorization on the global semi-sparse matrix 210 to generate the dense matrix for the globally trained matrix factorization model 220. The globally trained matrix factorization model 220 may be a dense matrix, having no empty values, and may include the depersonalized identifiers for rows and events for columns from the global semi-sparse matrix 210. The globally trained matrix factorization model 220 may be stored, for example, in the storage 170.

FIG. 2C shows an example arrangement for suitable for localization of machine learning models trained with global data according to an implementation of the disclosed subject matter. The data filter 130 may generate a data set of event data from the global data set for users from a particular group that may be used to generate a localization group data set to localize the globally trained matrix factorization model 220 to the group. For example, the data filter 130 may select and extract event data from the global semi-sparse matrix 210 for users of the tenant A, for example, users who have even data in the tenant A event data 182. The event data for the users from the tenant A used by the data filter 130 to generate the localization group data set 230 may include event data from tenants of the database 181 other than the tenant A, such event data from tenant B event data 183, tenant C event data 184, and tenant D event data 185, if the users of tenant A are also users of those tenants. The localization group data set 230 may be, for example, a set of rows extracted from the global semi-sparse matrix 210. The data filter 130 may hash or otherwise depersonalize the user identifiers from the tenant A event data 182 in the same manner as the matrix generator 110, and may use the depersonalized identifiers to select the appropriate rows of event data to extract from the global semi-sparse matrix 210, for example, matching the depersonalized identifiers generated from the user identifiers of the tenant A event data 182 with depersonalized identifiers in the global semi-sparse matrix 210. The localization group data set 230 may be stored, for example, in the storage 170.

FIG. 2D shows an example arrangement for suitable for localization of machine learning models trained with global data according to an implementation of the disclosed subject matter. The matrix generator 110 may generate a local semi-sparse matrix 240 by unioning the globally trained matrix factorization model 220 and the localization group data set 230. The matrix generator 110 may union the globally trained matrix factorization model 220 and the localization group data set 230 by, for example, appending the rows of the localization group data set 230 to the bottom of the globally trained matrix factorization model 220. This may result in the local semi-sparse matrix 240 including both the dense matrix of the globally trained matrix factorization model 220 and the rows from globally semi-sparse matrix 210 with event data for users of the tenant A. The local semi-sparse matrix 240 may have the same number of columns as and more rows than the globally trained matrix factorization model 220. The local semi-sparse matrix 240 may be stored, for example, in the storage 170.

FIG. 2E shows an example arrangement for suitable for localization of machine learning models trained with global data according to an implementation of the disclosed subject matter. The matrix factorizer 120 may generate a dense matrix from the local semi-sparse matrix 240. The dense matrix generated by the matrix factorizer 120 may be a localized matrix factorization model 250, which may be a localization of the globally trained matrix factorization model 220 to the users of tenant A that are part of the tenant A event data 182. The matrix factorizer 120 may, for example, perform non-negative matrix factorization on the local semi-sparse matrix 240 to generate the dense matrix for the localized matrix factorization model 250. The localized matrix factorization model 250 may be a dense matrix, having no empty values, and may include the depersonalized identifiers for rows and events for columns from the global semi-sparse matrix 210. The localized matrix factorization model 250 may be stored, for example, in the storage 170.

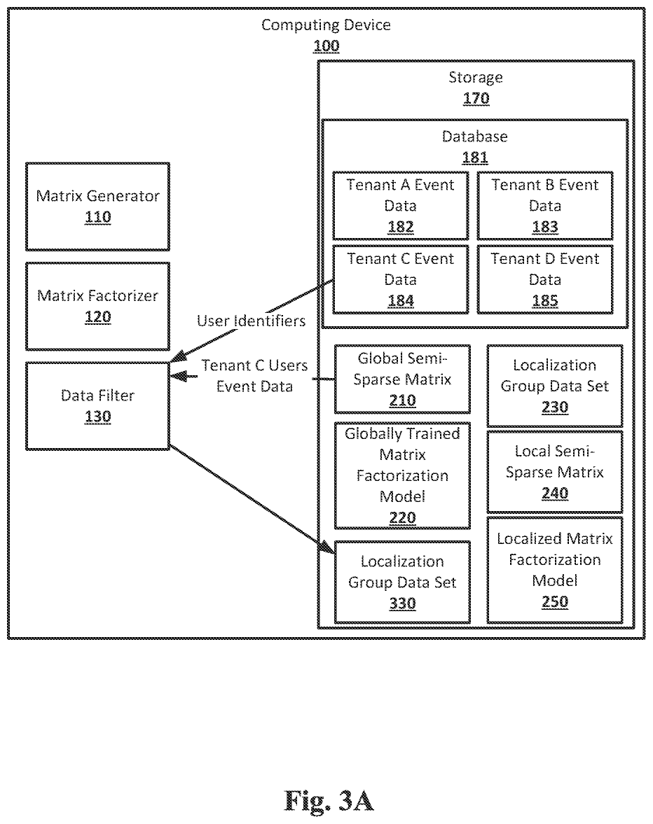

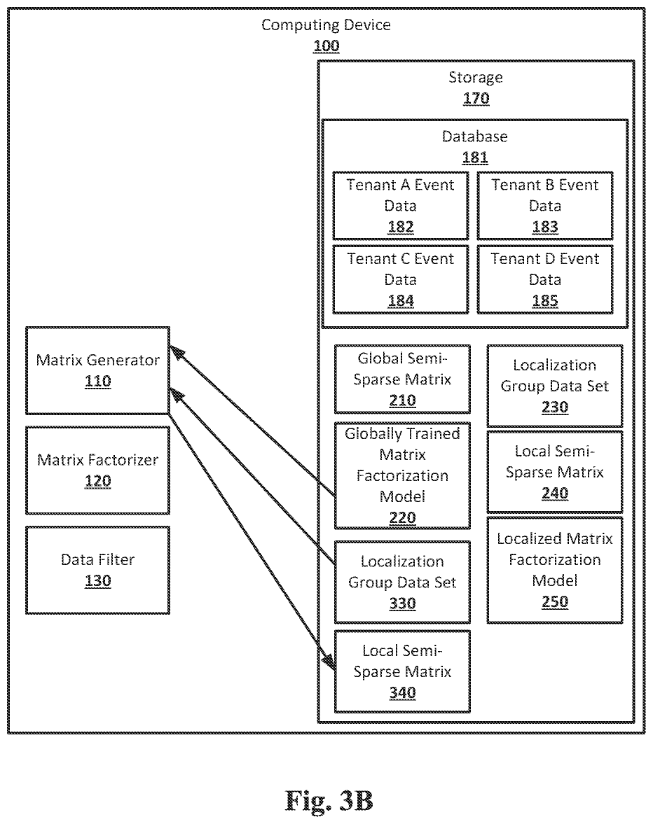

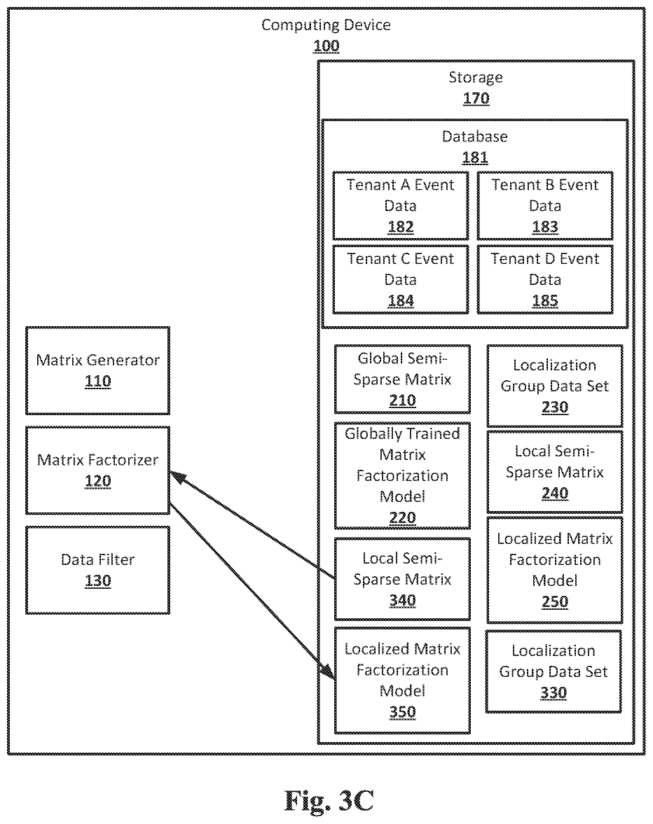

FIG. 3A shows an example arrangement for suitable for localization of machine learning models trained with global data according to an implementation of the disclosed subject matter. The globally trained matrix factorization model 220 may be localized to another one of the tenants of the database 181, for example, the tenant C. The data filter 130 may select and extract event data from the global semi-sparse matrix 210 for users of the tenant C, for example, users who have even data in the tenant C event data 184 to generate a localization group data set 330. The event data for the users from the tenant C used by the data filter 130 to generate the localization group data set 330 may include event data from tenants of the database 181 other than the tenant C, such event data from tenant A event data 182, tenant B event data 183, and tenant D event data 185, if the users of tenant C are also users of those tenants. The localization group data set 330 may be, for example, a set of rows extracted from the global semi-sparse matrix 210. The data filter 130 may hash or otherwise depersonalize the user identifiers from the tenant C event data 184 in the same manner as the matrix generator 110, and may use the depersonalized identifiers to select the appropriate rows of event data to extract from the global semi-sparse matrix 210, for example, matching the depersonalized identifiers generated from the user identifiers of the tenant C event data 184 with depersonalized identifiers in the global semi-sparse matrix 210. The localization group data set 330 may be stored, for example, in the storage 170.

FIG. 3B shows an example arrangement for suitable for localization of machine learning models trained with global data according to an implementation of the disclosed subject matter. The matrix generator 110 may generate a local semi-sparse matrix 340 by unioning the globally trained matrix factorization model 220 and the localization group data set 330. The matrix generator 110 may union the globally trained matrix factorization model 220 and the localization group data set 330 by, for example, appending the rows of the localization group data set 330 to the bottom of the globally trained matrix factorization model 220. This may result in the local semi-sparse matrix 240 including both the dense matrix of the globally trained matrix factorization model 220 and the rows from globally semi-sparse matrix 210 with event data for users of the tenant C. The local semi-sparse matrix 340 may have the same number of columns as and more rows than the globally trained matrix factorization model 220. The local semi-sparse matrix 340 may be stored, for example, in the storage 170.

FIG. 3C shows an example arrangement for suitable for localization of machine learning models trained with global data according to an implementation of the disclosed subject matter. The matrix factorizer 120 may generate a dense matrix from the local semi-sparse matrix 340. The dense matrix generated by the matrix factorizer 120 may be a localized matrix factorization model 350, which may be a localization of the globally trained matrix factorization model 220 to the users of tenant C that are part of the tenant C event data 182. The matrix factorizer 120 may, for example, perform non-negative matrix factorization on the local semi-sparse matrix 340 to generate the dense matrix for the localized matrix factorization model 350. The localized matrix factorization model 350 may be a dense matrix, having no empty values, and may include the depersonalized identifiers for rows and events for columns from the global semi-sparse matrix 210. The localized matrix factorization model 350 may be stored, for example, in the storage 170.

The localized matrix factorization model 350 may coexist with the localized matrix factorization model 250, and may be used by their respective tenants to generate recommendations. For example, the tenant A may use the localized matrix factorization model 250 to generate recommendations for users of a website or application belonging to the tenant A, while the tenant C may use the localized matrix factorization model 350 to generate recommendations for users of a website or application belonging to the tenant C. The recommendations generated by the localized matrix factorization model 250 may be more useful or relevant to the users of the website or application belonging to tenant A than recommendations that would be generated by the globally trained matrix factorization model 220 and the localized matrix factorization model 350, and the localized matrix factorization model 250 may be localized to the users of the website or application belonging to tenant A.

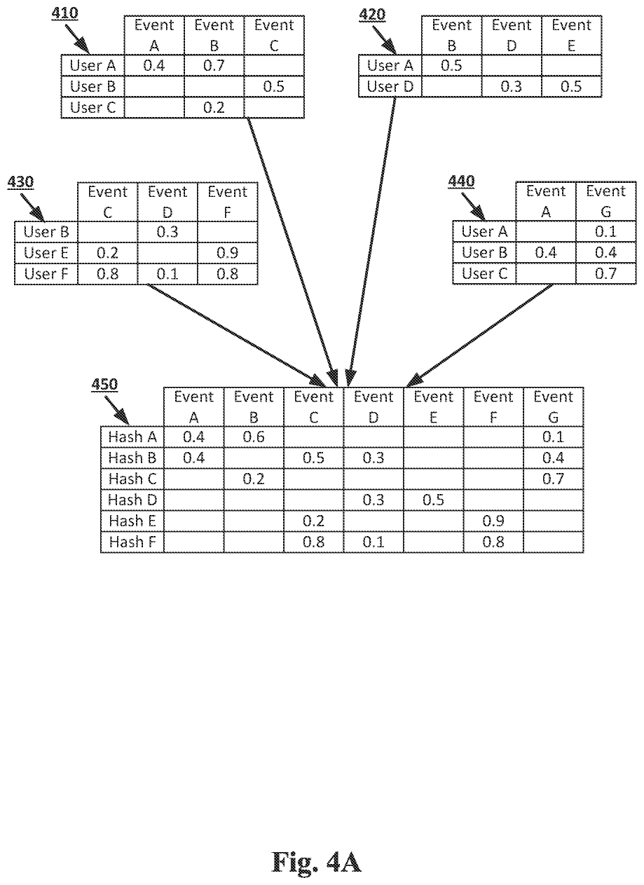

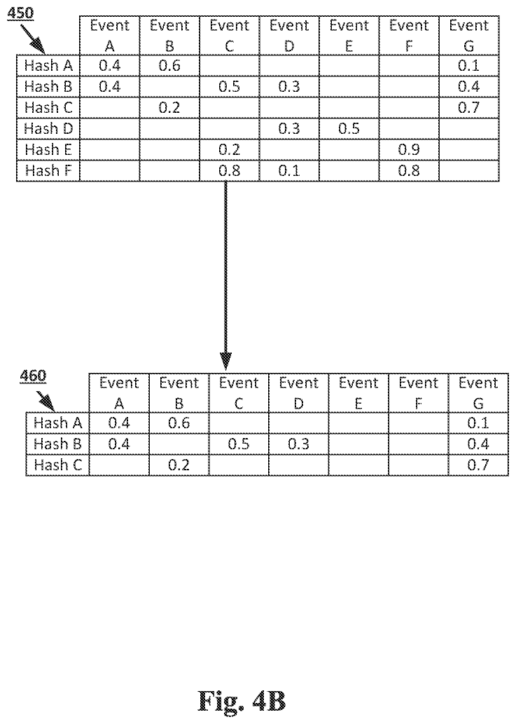

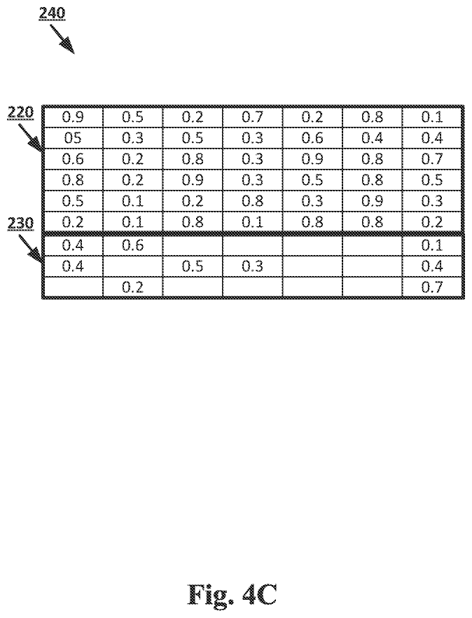

FIG. 4A shows an example arrangement for suitable for localization of machine learning models trained with global data according to an implementation of the disclosed subject matter. A table 410 may represent the tenant A event data 182, and may include values indicating the preference of users A, B, and C of tenant A regarding events A, B and C, which may be, for example, items or products and actions related to items or products offered by the tenant A, which may be a business or other organization. A table 420 may represent the tenant B event data 183, and may include values indicating the preference of users A and D of tenant B regarding events B, D, and E, which may be, for example, items or products and actions related to items or products offered by the tenant B, which may be a business or other organization. A table 430 may represent the tenant C event data 184, and may include values indicating the preference of users B, E, and F of tenant C regarding events C, D, and F, which may be, for example, items or products and actions related to items or products offered by the tenant C, which may be a business or other organization. A table 440 may represent the tenant D event data 185, and may include values indicating the preference of users A, B, and C of tenant D regarding events A and G which may be, for example, items or products and actions related to items or products offered by the tenant D, which may be a business or other organization. The user A may be common to the tenant A, tenant B, and tenant D. The user B may be common to the tenant A, tenant C, and tenant D. The user C may be common to the tenant A and the tenant D. The event A may be common to the tenant A and the tenant D. The event B may be common to the tenant A and the tenant B. The event C may be common to the tenant A and the tenant C. the event D may be common to the tenant B and the tenant C.

A table 450 may represent the event data of the global semi-sparse matrix 210, which may be generated by, for example, the matrix generator 110 combining and merging the tenant A event data 182, the tenant B event data 183, the tenant C event data 184, and the tenant D event data 185. The global semi-sparse matrix 210 may include event data for the users A, B, C, D, E, and F, using depersonalized user identifiers that may be, for example, hashes of the user identifiers. This may, for example, prevent event data for “hash A” from the table 450 from being connected back to the user A of the tenant A, tenant B, and tenant D by a party with only access to the table 450. The table 450 may include all of the event data represented in the tables 410, 420, 430, and 440. Event data for common users may be merged into the same row in the table 450, and event data for the same user and event from two different tables may have their values merged, for example, averaged, in the table 450. For example, the row for “hash A” may represent all of the event data for user A across the tenant A event data 182, the tenant B event data 183, the tenant C event data 184, and the tenant D event data 185, including a merging of the values for user A regrading event B from the table 410 and the table 420.

The globally trained matrix factorization model 220 may be generated, by, for example, the matrix factorizer 120 using non-negative matrix factorization on the local semi sparse matrix 340, as represented the table 450, to generate a dense matrix with not empty values.

FIG. 4B shows an example arrangement for suitable for localization of machine learning models trained with global data according to an implementation of the disclosed subject matter. To localize the globally trained matrix factorization model 220 to the tenant A, the localization group data set 230 may be generated based on users of the tenant A, for example, the users A, B, and C as represented in the table 410. The data filter 130 may select and extract event data for the users A, B, and C from the global semi-sparse matrix 210, as represented by the table 450, to generate the localization group data set 230, which may be represented by the table 460. The data filter 130 may first depersonalize the user identifiers for the users A, B, and C, for example, hashing the user identifiers to hash A, hash B, and hash C, and then select the corresponding rows from the global semi-sparse matrix 210 to generate the localization group data set 230.

FIG. 4C shows an example arrangement for suitable for localization of machine learning models trained with global data according to an implementation of the disclosed subject matter. The localization group data set 230 may be unioned to the globally trained matrix factorization model 220 to generate the local semi-sparse matrix 240, which may then be used to generate the localized matrix factorization model 250 for tenant A through non-negative matrix factorization. For example, the matrix generator 110 may append the rows of the localization group data set 230 to the bottom of the dense matrix of the globally trained matrix factorization model 220.

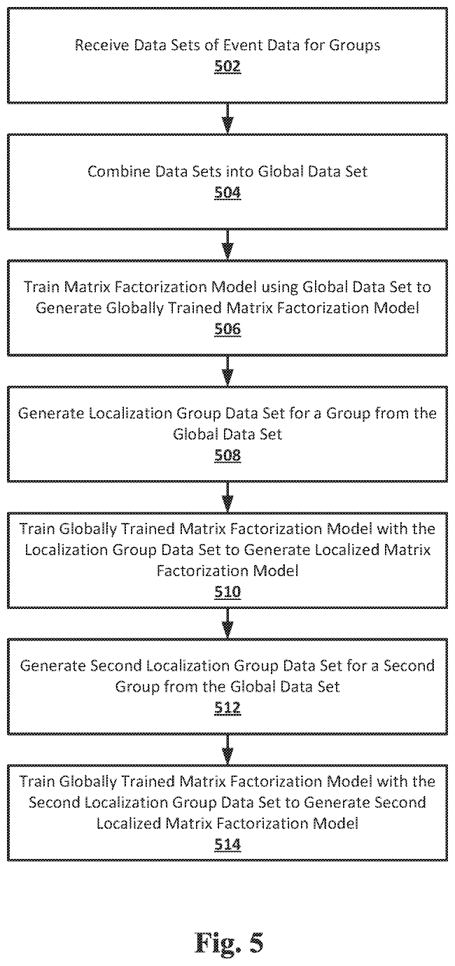

FIG. 5 shows an example procedure suitable for localization of machine learning models trained with global data according to an implementation of the disclosed subject matter. At 502, data sets of event data for groups may be received. For example, the matrix generator 110 may receive data sets of event data from the database 181 for groups that may be tenants of the database 181, which may be a multi-tenant database. The data sets of event data may include, for example, the tenant A event data 182, the tenant B event data 183, the tenant C event data 184, and the tenant D event data 185. In some implementations, the data sets for event data may be received from multiple databases, which may be multi-tenant or single-tenant databases. The event data may be, for example, data indicating user preferences for items or products offered on websites or applications operated by the groups, which may be, for example, businesses or other organization. The users may be, for example, customers or subscribers of the business or organizations.

At 502, the data sets may be combined into a global data set. For example, the matrix generator 110 may combine and merge the data sets of event data received from the database 181 into a global data set by combing the tenant A event data 182, the tenant B event data 183, the tenant C event data 184, and the tenant D event data 185 into the global semi-sparse matrix 210, which may be a semi-sparse matrix of the global data set. The matrix generator 110 may depersonalize user identifiers and merge event data for common users from the groups when generating the global semi-sparse matrix 210.

At 506, a matrix factorization model may be trained using the global data set to generate a globally trained matrix factorization model. For example, the matrix factorizer 120 may perform non-negative matrix factorization on the global semi-sparse matrix 210 of the global data set, generating a dense matrix that may be the globally trained matrix factorization model 220.

At 508, a localization group data set may be generated for a group from the global data set. For example, the data filter 130 may select and extract event data for users of the tenant A from the global semi-sparse matrix 210 of the global data set. The extracted event data may be rows of the global semi-sparse matrix 210, and may include event data for the users of the tenant A from any of the tenant A event data 182, the tenant B event data 183, the tenant C event data 184, and the tenant D event data 185. The extracted event data may be, for example, the localization group data set 230, which may be specific to the tenant A.

At 510, the globally trained matrix factorization model may be trained with the localization group data set to generate a localized matrix factorization model. For example, the matrix generator 110 may union the localization group data set 230 with the globally trained matrix factorization model 220 to generate the local semi-sparse matrix 240. The matrix factorizer may then perform non-negative matrix factorization on the local semi-sparse matrix 240, generating the localized matrix factorization model 250. The localized matrix factorization model 250 may be a matrix factorization model that may be both trained on all of the event data from the tenant A event data 182, the tenant B event data 183, the tenant C event data 184, and the tenant D event data 185, as represented in the global semi-sparse matrix 210 of the global data set, and localized to the tenant A, and the users of the tenant A and their event data across all tenants, as represented by the localization group data set 230.

At 512, a second localization group data set may be generated for a second group from the global data set. For example, the data filter 130 may select and extract event data for users of the tenant C from the global semi-sparse matrix 210 of the global data set. The extracted event data may be rows of the global semi-sparse matrix 210, and may include event data for the users of the tenant C from any of the tenant A event data 182, the tenant B event data 183, the tenant C event data 184, and the tenant D event data 185. The extracted event data may be, for example, the localization group data set 330, which may be specific to the tenant C.

At 514, the globally trained matrix factorization model may be trained with the second localization group data set to generate a second localized matrix factorization model. For example, the matrix generator 110 may union the localization group data set 330 with the globally trained matrix factorization model 220 to generate the local semi-sparse matrix 340. The matrix factorizer may then perform non-negative matrix factorization on the local semi-sparse matrix 340, generating the localized matrix factorization model 350. The localized matrix factorization model 350 may be a matrix factorization model that may be both trained on all of the event data from the tenant A event data 182, the tenant B event data 183, the tenant C event data 184, and the tenant D event data 185, as represented in the global semi-sparse matrix 210 of the global data set, and localized to the tenant C, and the users of the tenant C and their event data across all tenants, as represented by the localization group data set 330.

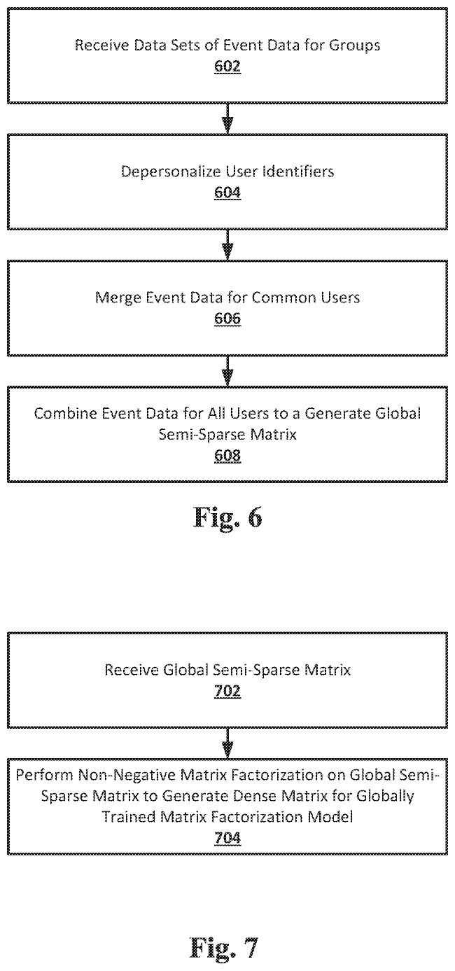

FIG. 6 shows an example procedure suitable for localization of machine learning models trained with global data according to an implementation of the disclosed subject matter. At 602, sets of event data for groups may be received. For example, the matrix generator 110 may receive data sets of event data from the database 181 for groups that may be tenants of the database 181, which may be a multi-tenant database. The data sets of event data may include, for example, the tenant A event data 182, the tenant B event data 183, the tenant C event data 184, and the tenant D event data 185. In some implementations, the data sets for event data may be received from multiple databases, which may be multi-tenant or single-tenant databases. The event data may be, for example, data indicating user preferences for items or products offered on websites or applications operated by the groups, which may be, for example, businesses or other organization. The users may be, for example, customers or subscribers of the business or organizations. FIG. 11 shows an example procedure suitable for localization of machine learning models trained with global data according to an implementation of the disclosed subject matter. At 1102, a user vector may be received. For example, a user vector may be received as input at the transformer neural network 160. The user vector may be for an existing user, and may be received from the live data set 883, or may be for a new user, and may be received after being generated by the user vector generator 910.

At 604, user identifiers may be depersonalized. For example, the matrix generator 110 may hash, or otherwise depersonalize, the user identifiers in the tenant A event data 182, the tenant B event data 183, the tenant C event data 184, and the tenant D event data 185, in a consistent manner, generating depersonalized identifiers. If a user is common to two different groups the depersonalized identifier for that user may be the same across the two different groups, allowing event data for the user to be merged. For example, if a user A is common to the tenant A and the tenant B, depersonalizing the user identifier for the user A from the tenant A event data 182 and the tenant B event data 183 may result in the same depersonalized identifier, allowing for the merging of the user A's event data across the tenant A and the tenant B.

At 606, event data for common users may be merged. For example, the matrix generator 110 may merge event data from different groups for the same user. For example, if a user A is common to the tenant A and the tenant B, the event data for the user A from the tenant A event data 182 and the tenant B event data 183 may be merged, generating a single row for the user A including all of the event data from the tenant A and the tenant B, including all event from the tenant A and tenant B. If there are events common to the tenant A and the tenant B, the values for the user for the common events may also be merged, for example, averaged, or combined in any other suitable manner.

At 608, event data for all users may be combined to generate a global semi-sparse matrix. For example, the matrix generator 110 may combine all of the event data for all users from the tenant A event data 182, the tenant B event data 183, the tenant C event data 184, and the tenant D event data 185, including merged event data for common users, into the global semi-sparse matrix 210, which may be semi-sparse matrix of a global data set. The global semi-sparse matrix 210 may include all of the users, events, and values from the tenant A event data 182, the tenant B event data 183, the tenant C event data 184, and the tenant D event data 185, and may include empty values for combinations of user and event for which none of the tenant A event data 182, the tenant B event data 183, the tenant C event data 184, and the tenant D event data 185 have a value.

FIG. 7 shows an example procedure suitable for localization of machine learning models trained with global data according to an implementation of the disclosed subject matter. At 702, a global semi-sparse matrix may be received. For example, the matrix factorizer 120 may receive the global semi-sparse matrix 210, which may have been generated from event data from the database 181, including the tenant A event data 182, the tenant B event data 183, the tenant C event data 184, and the tenant D event data 185.

At 704, non-negative matrix factorization may be performed on the global semi-sparse matrix to generate a dense matrix for a globally trained matrix factorization model. For example, the matrix factorizer 120 may perform non-negative matrix factorization on the global semi-sparse matrix 210, generating a dense matrix that may be the globally trained matrix factorization model 220. The performance of non-negative matrix factorization on the global semi-sparse matrix 210 may be the training of the globally trained matrix factorization model 220.

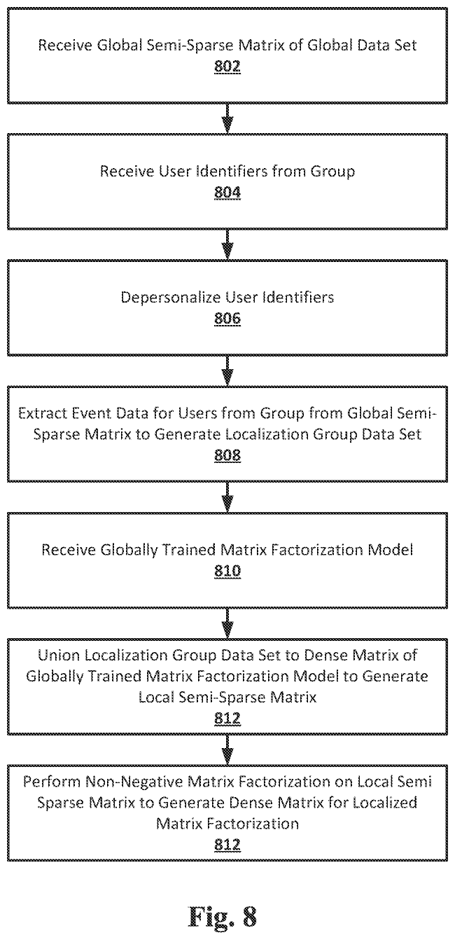

FIG. 8 shows an example procedure suitable for localization of machine learning models trained with global data according to an implementation of the disclosed subject matter. At 802, a global semi-sparse matrix of a global data set may be received. For example, the data filter 130 may receive the global semi-sparse matrix 210, which may have been generated from event data from the database 181, including the tenant A event data 182, the tenant B event data 183, the tenant C event data 184, and the tenant D event data 185.

At 804, user identifiers from a group may be received. The data filter 130 may receive user identifiers for the users of a group whose event data is part of the global data set received at the data filter 130. For example, the data filter 130 may receive the user identifiers for the users of the tenant A from the tenant A event data 182 after receiving the global semi-sparse matrix 210 which includes the tenant A event data 182.

At 806, user identifiers may be depersonalized. For example, the data filter 130 may depersonalize the user identifiers received for the users of tenant A from the tenant A event data 182 in the same manner that the user identifiers were depersonalized when the global semi-sparse matrix 210 was generated, generating depersonalized identifiers for each of the users of tenant A.

At 808, event data for users from the group may be extracted from the global semi-sparse matrix to generate a localization group data set. For example, the data filter 130 may use the depersonalized identifiers generated for the users of the tenant A to select rows of the global semi-sparse matrix 210 with the matching depersonalized identifiers. These rows may include event data from the tenant A event data 182, the tenant B event data 183, the tenant C event data 184, and the tenant D event data 185 for the users from the tenant A. The selected rows may be extracted, through copying of the rows, to generate the localization group data set 230, which may be a localization group data set for the tenant A.

At 810, a globally trained matrix factorization model may be received. For example, the matrix generator 110 may receive the globally matrix factorization model 220, which may have been generated through non-negative matrix factorization of the global semi-sparse matrix 210.

At 812, the localization group data set may be unioned to the dense matrix of the globally trained matrix factorization model to generate a local semi-sparse matrix. For example, the matrix generator 110 may union the localization group data set 230, as generated by the data filter 130, to the dense matrix of the globally trained matrix factorization model 220, generating the local semi-sparse matrix 240. The matrix generator 110 may union the localization group data set 230 to the dense matrix of the globally trained matrix factorization model 220 by, for example, appending the rows of the localization group data set 230 to the bottom of the dense matrix of the globally trained matrix factorization model 220.

At 814, non-negative matrix factorization may be performed on the local semi-sparse matrix to generate a dense matrix for a localized matrix factorization model. For example, the matrix factorizer 120 may perform non-negative matrix factorization on the local semi-sparse matrix 240, generating a dense matrix that may be the localized matrix factorization model 250. The performance of non-negative matrix factorization on the local semi-sparse matrix 240 may be the training of the localized matrix factorization model 250. The localized matrix factorization model 250 may be localized to the tenant A, and may generate better or more useful recommendations for users of a website or application operated by the tenant A, including for new users, than the globally trained matrix factorization model 220.

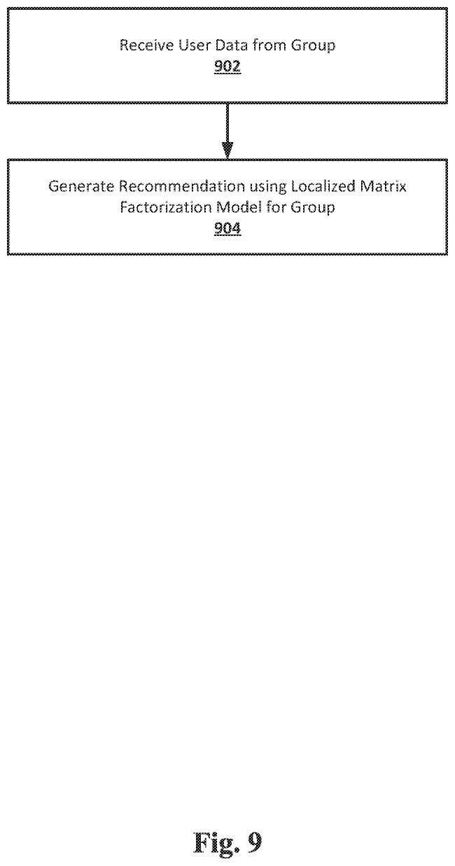

FIG. 9 shows an example procedure suitable for localization of machine learning models trained with global data according to an implementation of the disclosed subject matter. At 902, user data from a group may be received. For example, user data for a user of an application or website operated by the tenant A may be received at the computing device 100. The user data may include, for example, event data for the user generated based on the users' interactions with the website or application operated by the tenant A.

At 904, a localized matrix factorization model for the group may be used to generate recommendations. For example, the user data received for the user of tenant A may be used with the localized matrix factorization model 250, which may be the localized matrix factorization model for tenant A, to generate recommendations. The recommendations may be in any suitable form, and may be recommendations for the user of the tenant A of, for example, products or items offered by the tenant A. The recommendations may be sent to the user in any suitable manner. This may include, for example, generating and sending electronic communications, such as emails and SMS and MMS messages, with the recommendations, or displaying the recommendations to the user when the user views a webpage or application operated by the then tenant A, for example, of an online store in which the items are available, or displaying the recommendations in advertising shown to the user on webpages outside of the online store. The recommendations may be for products or items, or services offered by the tenant A that may be purchased or otherwise obtained by the user.

The localized matrix factorization model used to make recommendations may depend on which group the user data for the user was received from. For example, if the user data had been received from tenant C, the localized matrix factorization model 350 may have been used to generated recommendations, as the localized matrix factorization model 350 may been localized to the tenant C, and may thus generated more useful recommendations for a user of the tenant C than either the globally trained matrix factorization model 220 or the localized matrix factorization model 250.

Implementations of the presently disclosed subject matter may be implemented in and used with a variety of component and network architectures. FIG. 10 is an example computer 20 suitable for implementing implementations of the presently disclosed subject matter. As discussed in further detail herein, the computer 20 may be a single computer in a network of multiple computers. As shown in FIG. 10, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 11.

Many other devices or components (not shown) may be connected in a similar manner (e.g., document scanners, digital cameras and so on). Conversely, all of the components shown in FIG. 10 need not be present to practice the present disclosure. The components can be interconnected in different ways from that shown. The operation of a computer such as that shown in FIG. 10 is readily known in the art and is not discussed in detail in this application. Code to implement the present disclosure can be stored in computer-readable storage media such as one or more of the memory 27, fixed storage 23, removable media 25, or on a remote storage location.

FIG. 11 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving two or more data sets of event data for users wherein each of the two or more data sets belongs a separate one of two or more groups;
combining the two or more data sets of event data to generate a global data set;
training a matrix factorization model using the global data set to generate a globally trained matrix factorization model;
generating a localization group data set comprising event data from the global data set for users from a first of the two or more groups; and
training the globally trained matrix factorization model with the localization group data set to generate a localized matrix factorization model for the first of the two or more groups.

2. The computer-implemented method of claim 1, further comprising:
generating a second localization group data set comprising event data from the global data set for users from a second of the two or more groups, wherein the second localization group data set is different from the localization group data set; and
training the globally trained matrix factorization model with the second localization group data set to generate a localized matrix factorization model for the second of the two or more groups.

3. The computer-implemented method of claim 1, wherein combining the two or more data sets of event data to generate a global data set comprises combining event data from the two or more data sets to generate a global semi-sparse matrix comprising the event data.

4. The computer-implemented method of claim 3, wherein training a matrix factorization model using the global data set to generate a globally trained matrix factorization model comprises performing non-negative matrix factorization on the global semi-sparse matrix to generate the globally trained matrix factorization model, wherein the globally trained matrix factorization model comprises a dense matrix with no empty values.

5. The computer-implemented method of claim 4, wherein training the globally trained matrix factorization model with the localization group data set to generate a localized matrix factorization model for the first of the two or more groups further comprises:
unioning the localization group data set with the globally trained matrix factorization model to generate a local semi-sparse matrix; and
performing non-negative matrix factorization on the local semi-sparse matrix to generate the localized matrix factorization model for the first of the two or more groups, wherein the localized matrix factorization model for the first of the two or more groups comprises a dense matrix with no empty values.

6. The computer-implemented method of claim 1, wherein the two or more groups are tenants of a multi-tenant database, and wherein the event data for users is stored in the multi-tenant database.

7. The computer-implemented method of claim 1, wherein the event data comprises values indicating user preferences based on interactions with products or items offered by the two or more groups.

8. The computer-implemented method of claim 1, further comprising:
receiving user data for a user of the first of the two or more groups;
generating a recommendation for the user of the first of the two or more groups using the user data and the localized matrix factorization model for the first of the two or more groups; and
sending the recommendation to the user of the first of the two or more groups using at least one type of electronic communication.

9. A computer-implemented system for localization of matrix factorization models trained with global data comprising:
one or more storage devices; and
a processor that receives two or more data sets of event data for users wherein each of the two or more data sets belongs a separate one of two or more groups, combines the two or more data sets of event data to generate a global data set, trains a matrix factorization model using the global data set to generate a globally trained matrix factorization model, generates a localization group data set comprising event data from the global data set for users from a first of the two or more groups, and trains the globally trained matrix factorization model with the localization group data set to generate a localized matrix factorization model for the first of the two or more groups.

10. The computer-implemented system of claim 9, wherein the processor further generates a second localization group data set comprising event data from the global data set for users from a second of the two or more groups, wherein the second localization group data set is different from the localization group data set, and trains the globally trained matrix factorization model with the second localization group data set to generate a localized matrix factorization model for the second of the two or more groups.

11. The computer-implemented system of claim 9, wherein the processor combines the two or more data sets of event data to generate a global data set by combining event data from the two or more data sets to generate a global semi-sparse matrix comprising the event data.

12. The computer-implemented system of claim 11, wherein the processor trains a matrix factorization model using the global data set to generate a globally trained matrix factorization model by performing non-negative matrix factorization on the global semi-sparse matrix to generate the globally trained matrix factorization model, wherein the globally trained matrix factorization model comprises a dense matrix with no empty values.

13. The computer-implemented system of claim 12, wherein the processor trains the globally trained matrix factorization model with the localization group data set to generate a localized matrix factorization model for the first of the two or more groups further by unioning the localization group data set with the globally trained matrix factorization model to generate a local semi-sparse matrix and performing non-negative matrix factorization on the local semi-sparse matrix to generate the localized matrix factorization model for the first of the two or more groups, wherein the localized matrix factorization model for the first of the two or more groups comprises a dense matrix with no empty values.

14. The computer-implemented system of claim 9, wherein the two or more groups are tenants of a multi-tenant database, and wherein the event data for users is stored in the multi-tenant database.

15. The computer-implemented system of claim 9, wherein the event data comprises values indicating user preferences based on interactions with products or items offered by the two or more groups.

16. The computer-implemented system of claim 9, wherein the processor further receives user data for a user of the first of the two or more groups, generates a recommendation for the user of the first of the two or more groups using the user data and the localized matrix factorization model for the first of the two or more groups, and sends the recommendation to the user of the first of the two or more groups using at least one type of electronic communication.

17. A system comprising: one or more computers and one or more storage devices storing instructions which are operable, when executed by the one or more computers, to cause the one or more computers to perform operations comprising:
receiving two or more data sets of event data for users wherein each of the two or more data sets belongs a separate one of two or more groups;
combining the two or more data sets of event data to generate a global data set;
training a matrix factorization model using the global data set to generate a globally trained matrix factorization model;
generating a localization group data set comprising event data from the global data set for users from a first of the two or more groups; and
training the globally trained matrix factorization model with the localization group data set to generate a localized matrix factorization model for the first of the two or more groups.

18. The system of claim 17, wherein the instructions that cause the one or more computers to perform operations comprising combining the two or more data sets of event data to generate a global data set further comprise instructions that cause the one or more computers to perform operations comprising combining event data from the two or more data sets to generate a global semi-sparse matrix comprising the event data.

19. The system of claim 18, wherein the instructions that cause the one or more computers to perform operations comprising training a matrix factorization model using the global data set to generate a globally trained matrix factorization model further comprise instructions that cause the one or more computers to perform operations comprising:
performing non-negative matrix factorization on the global semi-sparse matrix to generate the globally trained matrix factorization model, wherein the globally trained matrix factorization model comprises a dense matrix with no empty values.

20. The system of claim 19, wherein the instructions that cause the one or more computers to perform operations comprising raining the globally trained matrix factorization model with the localization group data set to generate a localized matrix factorization model for the first of the two or more groups further comprise instructions that cause the one or more computers to perform operations comprising:
unioning the localization group data set with the globally trained matrix factorization model to generate a local semi-sparse matrix; and
performing non-negative matrix factorization on the local semi-sparse matrix to generate the localized matrix factorization model for the first of the two or more groups, wherein the localized matrix factorization model for the first of the two or more groups comprises a dense matrix with no empty values.
